(19) United States
(12) Patent Application Publication
(10) Pub. No.: US 2024/0320478 A1
(43) Pub. Date: Sep. 26, 2024

(54) AUTOMATICALLY GENERATING DEVICE-RELATED TEMPORAL PREDICTIONS USING ARTIFICIAL INTELLIGENCE TECHNIQUES

(71) Applicant: Dell Products L.P., Round Rock, TX (US)

(72) Inventors: David J. Linsey, Marietta, GA (US); Bijan Kumar Mohanty, Austin, TX (US); Hung T. Dinh, Austin, TX (US)

(21) Appl. No.: 18/124,268

(22) Filed: Mar. 21, 2023

(51) Int. Cl. G06N 3/049; G06N 3/045; G06N 20/20

(52) U.S. Cl. CPC G06N 3/049; G06N 3/045; G06N 20/20

(57) ABSTRACT

Methods, apparatus, and processor-readable storage media for automatically generating device-related temporal predictions using artificial intelligence techniques are provided herein. An example computer-implemented method includes obtaining data pertaining to one or more aspects of at least one device-related repair task; generating one or more device-related temporal predictions associated with the at least one device-related repair task by processing at least a portion of the obtained data using one or more artificial intelligence techniques; and performing one or more automated actions based at least in part on at least a portion of the one or more device-related temporal predictions.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The field relates generally to information processing systems, and more particularly to techniques for processing data in such systems.

### BACKGROUND

With increasing commoditization of consumer electronics, timely and cost-effective servicing of repairable consumer electronics is an important value driver and differentiator. For example, executing onsite repairs can include the use of various service and/or logistics providers attempting to coordinate different procedures and capabilities across multiple geographic locations. However, using conventional device management techniques, estimating arrival and/or obtainment times for parts needed to perform one or more repairs can be error prone and/or inaccurate, leading to repair delays and/or resource wastage.

### SUMMARY

Illustrative embodiments of the disclosure provide techniques for automatically generating device-related temporal predictions using artificial intelligence techniques.

An exemplary computer-implemented method includes obtaining data pertaining to one or more aspects of at least one device-related repair task, and generating one or more device-related temporal predictions associated with the at least one device-related repair task by processing at least a portion of the obtained data using one or more artificial intelligence techniques. The method also includes performing one or more automated actions based at least in part on at least a portion of the one or more device-related temporal predictions.

Illustrative embodiments can provide significant advantages relative to conventional device management techniques. For example, problems associated with error prone and/or inaccurate techniques are overcome in one or more embodiments through for automatically generating device-related temporal predictions using artificial intelligence techniques.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for automatically generating device-related temporal predictions using artificial intelligence techniques in an illustrative embodiment.

FIG. 2 shows example system architecture in an illustrative embodiment.

FIG. 3 shows example architecture of a dense artificial neural network-based regressor in an illustrative embodiment.

FIG. 4 shows example pseudocode for data preprocessing in an illustrative embodiment.

FIG. 5 shows example pseudocode for encoding text-based values in an illustrative embodiment.

FIG. 6 shows example pseudocode for splitting data into training and testing datasets in an illustrative embodiment.

FIG. 7 shows example pseudocode for neural network model creation in an illustrative embodiment.

FIG. 8 shows example pseudocode for model training, validation, optimization and prediction in an illustrative embodiment.

FIG. 9 is a flow diagram of a process for automatically generating device-related temporal predictions using artificial intelligence techniques in an illustrative embodiment.

FIGS. 10 and 11 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

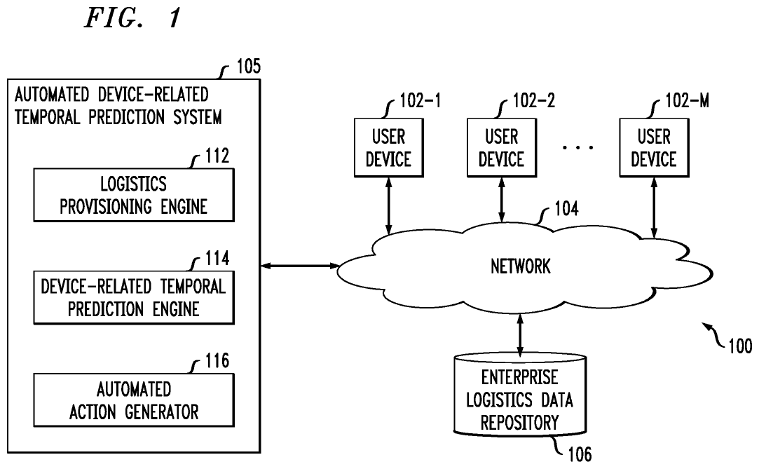

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated device-related temporal prediction system 105.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, automated device-related temporal prediction system 105 can have an associated enterprise logistics data repository 106 configured to store data such as user information, device and/or part information, location information, data pertaining to type of transaction (e.g., product shipping, parts for manufacturing, service, etc.), date-time information, logistics provider information, actual shipment or delivery time information, etc.

The enterprise logistics data repository 106 in the present embodiment is implemented using one or more storage systems associated with automated device-related temporal prediction system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with automated device-related temporal prediction system 105 are one or more input-output devices, which illustratively comprise keyboards, displays or other types of input-output devices in any combination. Such input-output devices can be used, for example, to support one or more user interfaces to automated device-related temporal prediction system 105, as well as to support communication between automated device-related temporal prediction system 105 and other related systems and devices not explicitly shown.

Additionally, automated device-related temporal prediction system 105 in the FIG. 1 embodiment is assumed to be implemented using at least one processing device. Each such processing device generally comprises at least one processor and an associated memory, and implements one or more functional modules for controlling certain features of automated device-related temporal prediction system 105.

More particularly, automated device-related temporal prediction system 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows automated device-related temporal prediction system 105 to communicate over the network 104 with the user devices 102, and illustratively comprises one or more conventional transceivers.

The automated device-related temporal prediction system 105 further comprises logistics provisioning engine 112, device-related temporal prediction engine 114, and automated action generator 116.

It is to be appreciated that this particular arrangement of elements 112, 114 and 116 illustrated in the automated device-related temporal prediction system 105 of the FIG. 1 embodiment is presented by way of example only, and alternative arrangements can be used in other embodiments. For example, the functionality associated with elements 112, 114 and 116 in other embodiments can be combined into a single module, or separated across a larger number of modules. As another example, multiple distinct processors can be used to implement different ones of elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for automatically generating device-related temporal predictions using artificial intelligence techniques involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, automated device-related temporal prediction system 105 and enterprise logistics data repository 106 can be on and/or part of the same processing platform.

An exemplary process utilizing elements 112, 114 and 116 of an example automated device-related temporal prediction system 105 in computer network 100 will be described in more detail with reference to the flow diagram of FIG. 9.

Accordingly, at least one embodiment includes automatically generating logistics delivery timeline estimations using artificial intelligence techniques. By incorporating an intelligent learning process which can monitor and/or identify one or more trends in connection with one or more synchronization needs across entities involved in at least one on-site repair task, one or more embodiments include improving reliability and efficiency of such tasks.

As further detailed herein, at least one embodiment includes estimating a logistics provider's delivery timeline of one or more parts, needed for one or more device repair tasks, in connection with synchronizing the support process by leveraging one or more machine learning models trained on historical, multi-dimensional parts shipping information. Such machine learning models can be implemented in conjunction with at least one logistics provider delivery estimation engine, which will consider a multitude of features and dimensions including, for example, device information, device parts information, user information, priority information, cost information, etc., to predict at least one delivery timeline of at least one device and/or part thereof. Such predictions can then be used to enable and/or facilitate improved scheduling (e.g., optimized scheduling) of field agents for servicing the device repair, device manufacturing, and/or device delivery processes.

Using an intelligent learning process which can process, for example, historical estimated time of arrival data and actual time of arrival data, missed and successful onsite repair information, regional and/or provider variations, etc., at least one embodiment can include accurately predicting one or more milestones for coordinated and/or synchronized steps in at least one device repair process (e.g., delivering both at least one technician and at least one needed device part as close in time as possible, thus anticipating one or more efficient times for scheduling the on-site technician(s) to carry out the device repair task).

One or more embodiments include utilizing historical data pertaining to logistics transactions including parts procurement, product delivery, returns and parts dispatches, etc., and leveraging at least one machine learning-based regression algorithm (also referred to herein as regressor) to predict the timeline of delivering at least one device and/or part thereof in connection with at least one repair task. Processing supply chain data, fulfillment data, work order and dispatch information from at least one enterprise resource planning (ERP) system and/or customer relationship management (CRM) system, etc., and extracting influencing features such as user information, device information, type of transaction, location, actual delivery time of each transaction, etc., and training at least one machine learning-based regressor using at least a portion of such features, the trained model can predict the delivery timeline of at least one future logistics transaction. As used herein, regressors include models that can predict a continuous numerical value (for example, the cost of a good, the time taken to deliver a product, etc.).

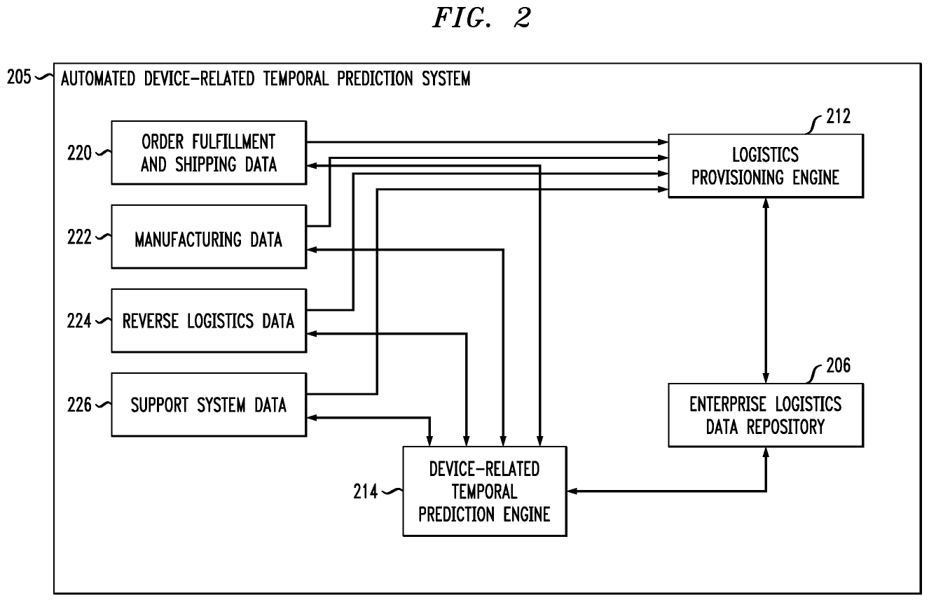

FIG. 2 shows example system architecture in an illustrative embodiment. By way of illustration, FIG. 2 depicts automated device-related temporal prediction system 205, which includes logistics provisioning engine 212, enterprise logistics data repository 206, and device-related temporal prediction engine 214. As further detailed herein, the device-related temporal prediction engine 214 ultimately predicts and/or estimates one or more delivery timelines of one or more devices and/or one or more parts thereof for at least one logistics provider (e.g., for shipping a device or one or more parts thereof, manufacturing a device or one or more parts thereof, delivering a device or one or more parts thereof, and/or supporting a repair task related to a device or one or more parts thereof) by leveraging artificial intelligence techniques such as one or more decision tree-based ensemble machine learning algorithms and/or at least one neural network-based regressor. Such artificial intelligence techniques can be trained using multi-dimensional, historical logistics transaction information derived from enterprise logistics data repository 206. As detailed herein, manufacturing supply chain entities and/or support systems (e.g., CRM) can utilize the predictions generated by automated device-related temporal prediction system 205 to manage resources associated with repair tasks (e.g., managing field labor scheduling for service delivery, product manufacturing, etc.).

As noted above and in accordance with one or more embodiments, decision tree-based ensemble algorithms implement multiple decision trees as weak learners, and then use the predictions generated and/or determined by those decision trees to produce a final prediction. In such an embodiment, ensemble learning can include using bagging (parallel) techniques and/or boosting (sequential) techniques. By way of illustration, random forest is an example ensemble bagging algorithm while gradient boosting is an example ensemble boosting algorithm. Ensemble learning algorithms can act as a regressor or a classifier (e.g., depending upon which version is chosen). In a regressor approach, the mean value of all predictions made by the group (e.g., decision trees) is calculated as the final output, and for a classifier approach, the mode value (e.g., the most frequent) is used as the final output.

Additionally, in one or more embodiments, neural networks can be used in connection with a regressor or a classifier, wherein a different mechanism is then used with a neural network architecture (e.g., input layer(s), hidden layer(s) and output layer(s) are implemented with one or more neurons in each layer). Different activation functions can be used to trigger a neuron, wherein the activation function typically varies for regressors and classifiers. For a regressor, a linear activation function or no activation function at the output layer is used while a sigmoid activation function or softmax activation function is used for a classifier.

Referring again to FIG. 2, with respect to enterprise logistics data repository 206, historical logistics data can be obtained from logistics provisioning engine 212, along with information such as actual shipment time data. Additionally, logistics provisioning engine 212 obtains and/or processes a variety of input data including order fulfillment and shipping data 220, manufacturing data 222, reverse logistics data 224, and support system data 226. More specifically, in at least one embodiment, logistics provisioning engine 212 can include a façade component that can take shipping requests from various enterprise systems for product delivery, parts shipping, and/or reverse logistics. In such an embodiment, logistics provisioning engine 212 interfaces with the logistics providers and sends requests for shipping. Further, logistics provisioning engine 212 can act as a single source to harvest logistics data, with actual delivery timelines, to be used in training the device-related temporal prediction engine 214.

In at least one embodiment, enterprise logistics data repository 206 obtains and stores data including, for example, product shipping data, part dispatch information from manufacturing, services and logistics systems, etc., and manages important attributes of such data by filtering out unnecessary information. Data engineering and data preprocessing can be carried out to understand and/or determine one or more data features and/or data elements that will influence predictions for delivery timelines associated with one or more devices and/or parts thereof. Such analysis can include, for example, multivariate plots and correlation heatmaps to identify the significance of one or more features in a given dataset, facilitating the filtering out of less important data elements and reducing the dimensionality and complexity of the model.

Additionally, enterprise logistics data repository 206 can contain information such as, for example, user information, device and/or part information, location information, data pertaining to type of transaction (e.g., product shipping, parts for manufacturing, service, etc.), date-time information, logistics provider information, actual shipment or delivery time information, etc. As noted above, various data elements can be stored in enterprise logistics data repository 206 and used for training one or more models of device-related temporal prediction engine 214.

In one or more embodiments, device-related temporal prediction engine 214 is responsible for predicting one or more estimated device-related delivery timelines based on one or more features used in at least one training dataset. As detailed herein, in such an embodiment, device-related temporal prediction engine 214 can utilize a deep learning approach leveraging at least one neural network (e.g., at least one artificial neural network) to develop a regression model capable of predicting one or more estimated device-related delivery times.

The device-related temporal prediction engine 214 can be used, for example, by support agents to obtain an estimation of parts arrival at a user location, such that the support agents can schedule labor resources (e.g., one or more field technicians) more accurately and reliably. Similarly, the device-related temporal prediction engine 214 can be used by other systems such as, e.g., sales systems, reverse logistics systems, manufacturing systems, etc., to facilitate the planning of resource-related processes. Additionally or alternatively, the device-related temporal prediction engine 214 can also provide foundational data for analyzing the performance of entities such as suppliers and logistics providers.

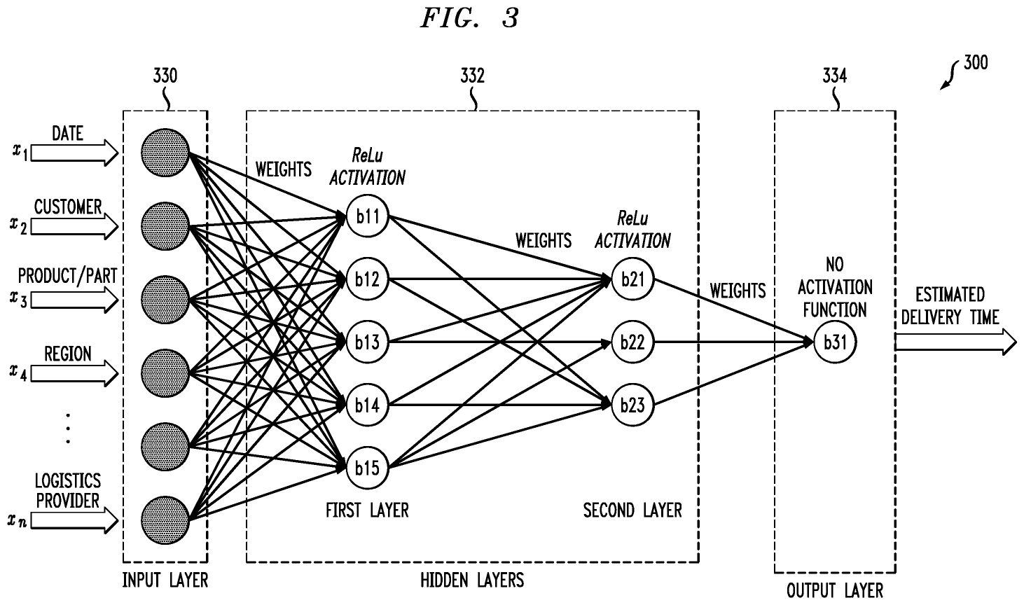

In at least one embodiment, device-related temporal prediction engine 214 leverages one or more supervised learning techniques and trains at least one model with historical data containing the actual delivery time of one or more devices or parts thereof, dispatch information associated with such devices and/or parts, etc. One or more important features can be determined and extracted from the dataset, wherein such features can include, for example, product information, parts information, user/customer information, location of delivery, location of manufacturing, material supplier information, logistics provider information, etc. During model training, at least a portion of such features can be fed to the model as the independent variables, and the actual delivery time(s) in the dataset can be fed to the model as the dependent/target value. Accordingly, and as further described in connection with FIG. 3, upon receiving a field dispatch with device and/or parts information, the trained model in device-related temporal prediction engine 214 can be used to predict the estimated delivery time of the device and/or parts.

FIG. 3 shows example architecture of a dense artificial neural network-based regressor in an illustrative embodiment. By way of illustration, FIG. 3 depicts neural network 300, which can be implemented by device-related temporal prediction engine 214 (as depicted in the example embodiment of FIG. 2) and act as regressor for predicting one or more temporal values. More specifically, neural network 300 includes an input layer 330, hidden layers 332 (which includes a first layer and a second layer in the example embodiment depicted in FIG. 3), and an output layer 334. Input layer 330 includes a number of neurons that matches the number of input/independent variables (e.g., date information (x₁), customer information (x₂), product or part information (x₃), region information (x₄), and logistics provider information (xₙ)). Hidden layers 332, as noted, include two layers in this example architecture, and the number of neurons on each layer (e.g., neurons b11, b12, b13, b14 and b15 on the first layer, and neurons b21, b22 and b23 on the second layer) depends upon the number of neurons in the input layer. The output layer 334 contains a single neuron b31, as this is a regression model, meaning that the output is a continuous, numerical value representing the expected time taken to deliver the device and/or part thereof.

Although there are five neurons shown in the first hidden layer and three neurons shown in the second hidden layer in the example depicted in FIG. 3, the actual values can depend on the total number of neurons in the input layer 330. For example, the number of neurons in the first hidden layer can be calculated using an algorithm matching the power of two to the number of input nodes. For instance, if the number of input variables is 19, the number of neurons falls in the range of 2⁵, meaning that the first layer will contain 2⁵=32 neurons, and the second layer will contain 2⁴=16 neurons. If there was to be a third layer, the third layer would contain 2³=8 neurons.

Additionally, in one or more embodiments, the neurons in the hidden layers and output layer can contain an activation function which drives if a given neuron will fire or not. In the example embodiment depicted in FIG. 3, a rectified linear unit (ReLU) activation function is used in both hidden layers, but because the model is being implemented as a regressor, the output neuron does not contain an activation function.

Also, as the example model depicted in FIG. 3 is a dense neural network, each neuron will connect with every other neuron, each connection can have a weight factor, and the neurons can each have a bias factor. These weight and bias values can be set randomly by the neural network (e.g., the values can be set as 1 or 0 for all the values). Further, each neuron can perform a linear calculation by combining the multiplication of each input variable (x1, x2, etc.) with their weight factors, and then adding the bias of the neuron. The formula for this calculation can be represented as follows: ws1=x1.w1+x2.w2+ . . . +b1, wherein ws1 represents the weighted sum of neuron1, x1, x2, etc. represent the input values to the model, w1, w2, etc. represent the weight values applied to the connections to neuron1, and b1 represents the bias value of neuron1. This weighted sum can then be input to an activation function (e.g., ReLU) to compute the value of the activation function. Similarly, the weighted sum and activation function values of all other neurons in the layer can be calculated and fed to the neuron(s) of the next layer.

In at least one embodiment, the same process can be repeated for the neuron(s) in the next layer until the values are fed to the neuron of the output layer, wherein the weighted sum is calculated and compared to the actual target value. Depending upon the difference, the loss value is calculated. This pass-through of the neural network is a forward propagation which calculates the error and drives a backpropagation through the network to minimize the loss at each neuron of the network. Considering the loss is generated by all of the neurons in the network, backpropagation goes through each layer, from back to front, and attempts to minimize the loss by using at least one gradient descent-based optimization mechanism. In one or more embodiments, wherein the neural network is used as a regressor, such an embodiment can include using mean_squared_error as the loss function, and using adaptive moment estimation (Adam) as the optimization algorithm.

A result of a backpropagation such as noted above can include adjusting the weight and/or bias values at each connection and/or neuron to reduce the loss. Additionally, once all of the observations of the training data are passed through the neural network, an epoch is completed, and another forward propagation is initiated with the adjusted weight and bias values, which are considered as epoch2. Further, the same process of forward and backpropagation can be repeated in one or more subsequent epochs, and this process can result in the reduction of loss to a small number (e.g., close to 0), at which point the neural network is considered to be sufficiently trained for prediction.

The implementation of at least a portion of one or more embodiments can be achieved, as depicted in FIG. 4 through FIG. 8, by using Keras with Tensorflow backend, Python language, Pandas, Numpy and ScikitLearn libraries.

FIG. 4 shows example pseudocode for data preprocessing in an illustrative embodiment. In this embodiment, example pseudocode 400 is executed by or under the control of at least one processing system and/or device. For example, the example pseudocode 400 may be viewed as comprising a portion of a software implementation of at least part of automated device-related temporal prediction system 105 of the FIG. 1 embodiment.

The example pseudocode 400 illustrates reading a dataset from the historical enterprise logistics transaction data repository and generating a Pandas data frame, which contains columns including independent variables and a column including the dependent/target variable. Additionally, one or more embodiments can include preprocessing the data to handle any null or missing values in the columns, wherein null or missing values in numerical columns can be replaced by the median value of that column. After performing initial data analysis by creating one or more univariate and bivariate plots of the columns, the importance and/or influence of each column can be determined, and columns which have limited or no role or influence on the actual delivery time (i.e., the target variable) can be removed.

It is to be appreciated that this particular example pseudocode shows just one example implementation of data preprocessing, and alternative implementations can be used in other embodiments.

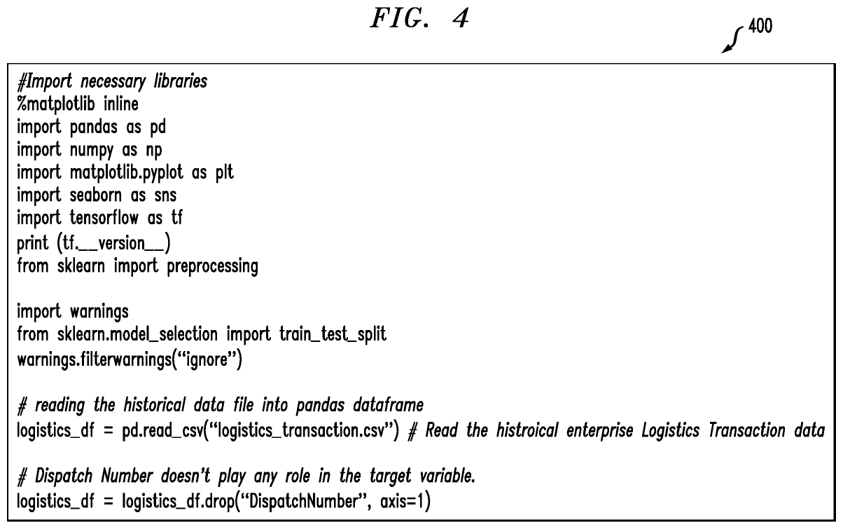

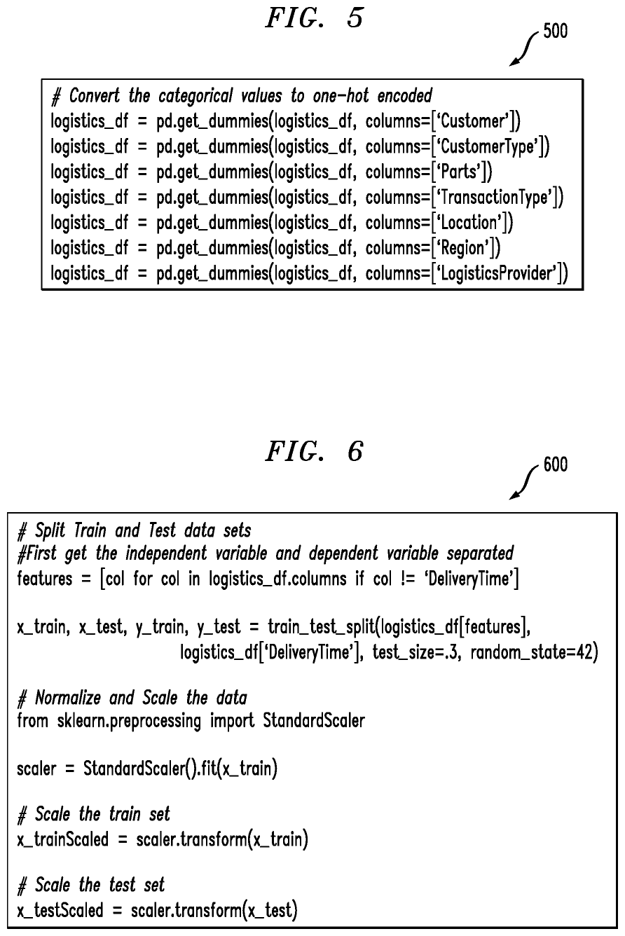

FIG. 5 shows example pseudocode for encoding text-based values in an illustrative embodiment. In this embodiment, example pseudocode 500 is executed by or under the control of at least one processing system and/or device. For example, the example pseudocode 500 may be viewed as comprising a portion of a software implementation of at least part of automated device-related temporal prediction system 105 of the FIG. 1 embodiment.

The example pseudocode 500 illustrates encoding textual categorical values in the columns must be encoded and converted to numerical values. This can be achieved by using one-hot encoding or dummy variable encoding (e.g., the get dummies function of pandas).

It is to be appreciated that this particular example pseudocode shows just one example implementation of encoding text-based values, and alternative implementations can be used in other embodiments.

FIG. 6 shows example pseudocode for splitting data into training and testing datasets in an illustrative embodiment. In this embodiment, example pseudocode 600 is executed by or under the control of at least one processing system and/or device. For example, the example pseudocode 600 may be viewed as comprising a portion of a software implementation of at least part of automated device-related temporal prediction system 105 of the FIG. 1 embodiment.

The example pseudocode 600 illustrates splitting a dataset into training and testing datasets using a train_test_split function of a ScikitLearn library (e.g., splitting the dataset as 70% training data and 30% testing data). Considering that one or more embodiments include a regression use case and using a dense neural network, the data can be scaled before passing to the model, and the scaling can be performed after the training and testing split is carried out. This can be achieved by passing the training and testing datasets to a StandardScaler of a ScikitLearn library. Subsequently, the datasets are ready for model training and testing.

It is to be appreciated that this particular example pseudocode shows just one example implementation of splitting data into training and testing datasets, and alternative implementations can be used in other embodiments.

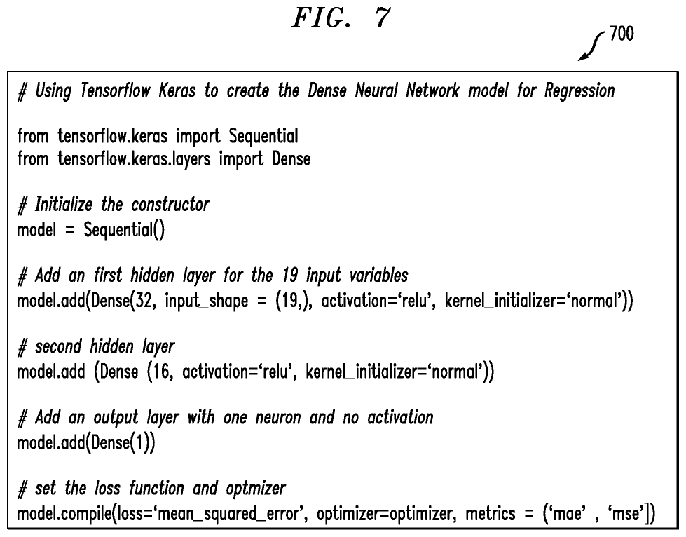

FIG. 7 shows example pseudocode for neural network model creation in an illustrative embodiment. In this embodiment, example pseudocode 700 is executed by or under the control of at least one processing system and/or device. For example, the example pseudocode 700 may be viewed as comprising a portion of a software implementation of at least part of automated device-related temporal prediction system 105 of the FIG. 1 embodiment.

The example pseudocode 700 illustrates creating a multi-layer dense neural network using a Keras library. More specifically, using the function Sequential( ) a shell model is created, and then individual layers are added by calling the add( ) function of the model and passing an instance of Dense( ) to indicate that it is a dense neural network that is being created. As such, all of the neurons in each layer will connect with all of the neurons from preceding and following layers. The Dense( ) function will accept parameters, for example, for the number of neurons on the given layer, the type of activation function used and if there are any kernel parameters. Multiple hidden layers and an output layer are added by calling the same add( ) function to the model. Once the model is created, a loss function, an optimizer type and one or more validation metrics are added to the model using a compile( ) function. In at least one embodiment, mean_squared_error is used as the loss function, Adam is used the optimizer, and mean square error (MSE) and mean absolute error (MAE) are used as the validation metrics.

It is to be appreciated that this particular example pseudocode shows just one example implementation of neural network model creation, and alternative implementations can be used in other embodiments.

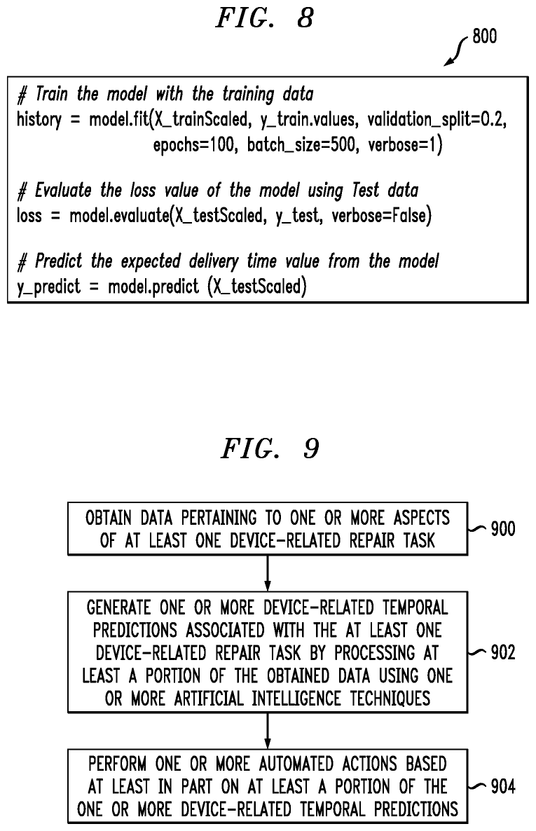

FIG. 8 shows example pseudocode for model training, validation, optimization and prediction in an illustrative embodiment. In this embodiment, example pseudocode 800 is executed by or under the control of at least one processing system and/or device. For example, the example pseudocode 800 may be viewed as comprising a portion of a software implementation of at least part of automated device-related temporal prediction system 105 of the FIG. 1 embodiment.

The example pseudocode 800 illustrates training the neural network model by calling a fit( ) function of the model and passing training data and the number of epochs. After the model completes the specified number of epochs, the model is considered trained and ready for validation. The loss value can be obtained by calling an evaluate( ) function of the model and passing testing data. This loss value indicates how well the model is trained, wherein a higher loss value indicates that the model is not sufficiently trained, and hyperparameter tuning may be required. Typically, the number of epochs can be increased to further train the model. Other hyperparameter tuning can be performed, for example, by changing the loss function, the optimizer algorithm, and/or making changes to the neural network architecture by adding one or more hidden layers. Once the model is trained with a reasonable value of loss (e.g., as close to zero as possible), the model is ready for generating predictions, which can be achieved by calling a predict( ) function of the model and passing the independent variables of the testing data (e.g., for comparing training versus testing data) or the real values that need to be processed for prediction and/or estimation of the expected delivery time (e.g., the target variable).

It is to be appreciated that this particular example pseudocode shows just one example implementation of model training, validation, optimization and prediction, and alternative implementations can be used in other embodiments.

It is to be appreciated that some embodiments described herein utilize one or more artificial intelligence models. It is to be appreciated that the term “model,” as used herein, is intended to be broadly construed and may comprise, for example, a set of executable instructions for generating computer-implemented predictions. For example, one or more of the models described herein may be trained to generate device-related temporal predictions based on manufacturing data, shipping data, product data, logistics data, support system data, etc., collected from various hardware components, and such predictions can be used to initiate one or more automated actions (e.g., automatically scheduling and/or provisioning one or more resources, automatically outputting communications to one or more entities associated with the given task, etc.).

FIG. 9 is a flow diagram of a process for automatically generating device-related temporal predictions using artificial intelligence techniques in an illustrative embodiment. It is to be understood that this particular process is only an example, and additional or alternative processes can be carried out in other embodiments.

In this embodiment, the process includes steps 900 through 904. These steps are assumed to be performed by automated device-related temporal prediction system 105 utilizing elements 112, 114 and 116.

Step 900 includes obtaining data pertaining to one or more aspects of at least one device-related repair task. In at least one embodiment, obtaining data pertaining to one or more aspects of at least one device-related repair task includes obtaining data pertaining to one or more of user information, device information, device part information, repair-related location information, device-related location information, repair task type, one or more temporal parameters associated with the at least one device-related repair task, and logistics provider information.

Step 902 includes generating one or more device-related temporal predictions associated with the at least one device-related repair task by processing at least a portion of the obtained data using one or more artificial intelligence techniques. In one or more embodiments, generating one or more device-related temporal predictions includes processing at least a portion of the obtained data using at least one neural network-based regressor. Additionally or alternatively, generating one or more device-related temporal predictions can include processing at least a portion of the obtained data using one or more decision tree-based ensemble machine learning algorithms.

Also, in at least one embodiment, generating one or more device-related temporal predictions includes generating at least one prediction for a delivery timeline for at least one of a device and one or more parts thereof to at least one location associated with the at least one device-related repair task. Additionally or alternatively, generating one or more device-related temporal predictions can include generating at least one prediction for a manufacturing timeline for at least one of a device and one or more parts thereof in connection with the at least one device-related repair task. Further, in one or more embodiments, generating one or more device-related temporal predictions includes generating at least one prediction for one or more support service implementation timelines associated with the at least one device-related repair task.

Step 904 includes performing one or more automated actions based at least in part on at least a portion of the one or more device-related temporal predictions. In at least one embodiment, performing one or more automated actions includes automatically provisioning one or more resources in accordance with at least one of the one or more device-related temporal predictions. Additionally or alternatively, performing one or more automated actions can include automatically generating and outputting, to one or more entities associated with the at least one device-related repair task, one or more communications pertaining to the at least a portion of the one or more device-related temporal predictions. Further, in one or more embodiments, performing one or more automated actions includes automatically training at least a portion of the one or more artificial intelligence techniques based at least in part on feedback related to the at least a portion of the one or more device-related temporal predictions.

Additionally, as detailed herein, the techniques depicted in FIG. 9 can include training at least a portion of the one or more artificial intelligence techniques using multi-dimensional historical logistics-related data associated with one or more device-related repair tasks.

Accordingly, the particular processing operations and other functionality described in conjunction with the flow diagram of FIG. 9 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically generate device-related temporal predictions using artificial intelligence techniques. These and other embodiments can effectively overcome problems associated with error prone and/or inaccurate techniques.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

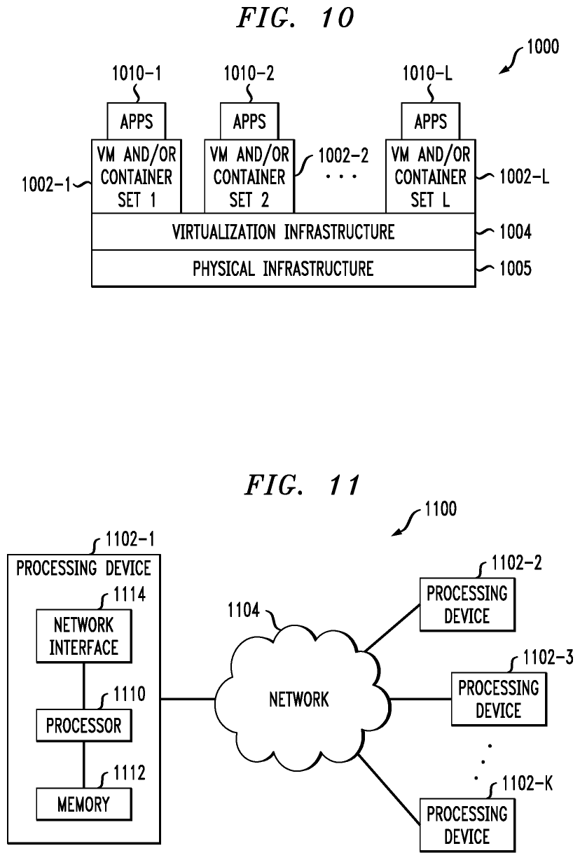

Illustrative embodiments of processing platforms will now be described in greater detail with reference to FIGS. 10 and 11. Although described in the context of system 100, these platforms may also be used to implement at least portions of other information processing systems in other embodiments.

FIG. 10 shows an example processing platform comprising cloud infrastructure 1000. The cloud infrastructure 1000 comprises a combination of physical and virtual processing resources that are utilized to implement at least a portion of the information processing system 100. The cloud infrastructure 1000 comprises multiple virtual machines (VMs) and/or container sets 1002-1, 1002-2, . . . 1002-L implemented using virtualization infrastructure 1004. The virtualization infrastructure 1004 runs on physical infrastructure 1005, and illustratively comprises one or more hypervisors and/or operating system level virtualization infrastructure. The operating system level virtualization infrastructure illustratively comprises kernel control groups of a Linux operating system or other type of operating system.

The cloud infrastructure 1000 further comprises sets of applications 1010-1, 1010-2, . . . 1010-L running on respective ones of the VMs/container sets 1002-1, 1002-2, . . . 1002-L under the control of the virtualization infrastructure 1004. The VMs/container sets 1002 comprise respective VMs, respective sets of one or more containers, or respective sets of one or more containers running in VMs. In some implementations of the FIG. 10 embodiment, the VMs/container sets 1002 comprise respective VMs implemented using virtualization infrastructure 1004 that comprises at least one hypervisor.

A hypervisor platform may be used to implement a hypervisor within the virtualization infrastructure 1004, wherein the hypervisor platform has an associated virtual infrastructure management system. The underlying physical machines comprise one or more information processing platforms that include one or more storage systems.

In other implementations of the FIG. 10 embodiment, the VMs/container sets 1002 comprise respective containers implemented using virtualization infrastructure 1004 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 1000 shown in FIG. 10 may represent at least a portion of one processing platform. Another example of such a processing platform is processing platform 1100 shown in FIG. 11.

The processing platform 1100 in this embodiment comprises a portion of system 100 and includes a plurality of processing devices, denoted 1102-1, 1102-2, 1102-3, . . . 1102-K, which communicate with one another over a network 1104.

The network 1104 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1102-1 in the processing platform 1100 comprises a processor 1110 coupled to a memory 1112.

The processor 1110 comprises a microprocessor, a CPU, a GPU, a TPU, a microcontroller, an ASIC, a FPGA or other type of processing circuitry, as well as portions or combinations of such circuitry elements.

The memory 1112 comprises random access memory (RAM), read-only memory (ROM) or other types of memory, in any combination. The memory 1112 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1102-1 is network interface circuitry 1114, which is used to interface the processing device with the network 1104 and other system components, and may comprise conventional transceivers.

The other processing devices 1102 of the processing platform 1100 are assumed to be configured in a manner similar to that shown for processing device 1102-1 in the figure.

Again, the particular processing platform 1100 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining data pertaining to one or more aspects of at least one device-related repair task;
generating one or more device-related temporal predictions associated with the at least one device-related repair task by processing at least a portion of the obtained data using one or more artificial intelligence techniques; and
performing one or more automated actions based at least in part on at least a portion of the one or more device-related temporal predictions;
wherein the method is performed by at least one processing device comprising a processor coupled to a memory.

2. The computer-implemented method of claim 1, wherein generating one or more device-related temporal predictions comprises processing at least a portion of the obtained data using at least one neural network-based regressor.

3. The computer-implemented method of claim 1, wherein generating one or more device-related temporal predictions comprises processing at least a portion of the obtained data using one or more decision tree-based ensemble machine learning algorithms.

4. The computer-implemented method of claim 1, wherein performing one or more automated actions comprises automatically provisioning one or more resources in accordance with at least one of the one or more device-related temporal predictions.

5. The computer-implemented method of claim 1, wherein performing one or more automated actions comprises automatically generating and outputting, to one or more entities associated with the at least one device-related repair task, one or more communications pertaining to the at least a portion of the one or more device-related temporal predictions.

6. The computer-implemented method of claim 1, wherein performing one or more automated actions comprises automatically training at least a portion of the one or more artificial intelligence techniques based at least in part on feedback related to the at least a portion of the one or more device-related temporal predictions.

7. The computer-implemented method of claim 1, wherein generating one or more device-related temporal predictions comprises generating at least one prediction for a delivery timeline for at least one of a device and one or more parts thereof to at least one location associated with the at least one device-related repair task.

8. The computer-implemented method of claim 1, wherein generating one or more device-related temporal predictions comprises generating at least one prediction for a manufacturing timeline for at least one of a device and one or more parts thereof in connection with the at least one device-related repair task.

9. The computer-implemented method of claim 1, wherein generating one or more device-related temporal predictions comprises generating at least one prediction for one or more support service implementation timelines associated with the at least one device-related repair task.

10. The computer-implemented method of claim 1, wherein obtaining data pertaining to one or more aspects of at least one device-related repair task comprises obtaining data pertaining to one or more of user information, device information, device part information, repair-related location information, device-related location information, repair task type, one or more temporal parameters associated with the at least one device-related repair task, and logistics provider information.

11. The computer-implemented method of claim 1, further comprising:
training at least a portion of the one or more artificial intelligence techniques using multi-dimensional historical logistics-related data associated with one or more device-related repair tasks.

12. A non-transitory processor-readable storage medium having stored therein program code of one or more software programs, wherein the program code when executed by at least one processing device causes the at least one processing device:
to obtain data pertaining to one or more aspects of at least one device-related repair task;
to generate one or more device-related temporal predictions associated with the at least one device-related repair task by processing at least a portion of the obtained data using one or more artificial intelligence techniques; and
to perform one or more automated actions based at least in part on at least a portion of the one or more device-related temporal predictions.

13. The non-transitory processor-readable storage medium of claim 12, wherein generating one or more device-related temporal predictions comprises processing at least a portion of the obtained data using at least one neural network-based regressor.

14. The non-transitory processor-readable storage medium of claim 12, wherein generating one or more device-related temporal predictions comprises processing at least a portion of the obtained data using one or more decision tree-based ensemble machine learning algorithms.

15. The non-transitory processor-readable storage medium of claim 12, wherein performing one or more automated actions comprises automatically provisioning one or more resources in accordance with at least one of the one or more device-related temporal predictions.

16. The non-transitory processor-readable storage medium of claim 12, wherein performing one or more automated actions comprises automatically generating and outputting, to one or more entities associated with the at least one device-related repair task, one or more communications pertaining to the at least a portion of the one or more device-related temporal predictions.

17. An apparatus comprising:
at least one processing device comprising a processor coupled to a memory;
the at least one processing device being configured:
to obtain data pertaining to one or more aspects of at least one device-related repair task;
to generate one or more device-related temporal predictions associated with the at least one device-related repair task by processing at least a portion of the obtained data using one or more artificial intelligence techniques; and
to perform one or more automated actions based at least in part on at least a portion of the one or more device-related temporal predictions.

18. The apparatus of claim 17, wherein generating one or more device-related temporal predictions comprises processing at least a portion of the obtained data using at least one neural network-based regressor.

19. The apparatus of claim 17, wherein generating one or more device-related temporal predictions comprises processing at least a portion of the obtained data using one or more decision tree-based ensemble machine learning algorithms.

20. The apparatus of claim 17, wherein performing one or more automated actions comprises automatically provisioning one or more resources in accordance with at least one of the one or more device-related temporal predictions.
